(19) United States
(12) Patent Application Publication
(10) Pub. No.: US 2024/0336757 A1
(43) Pub. Date: Oct. 10, 2024

(54) ANTIMICROBIAL COPPER BASED POLYURETHANE

(71) Applicant: Cupron, Inc., Richmond, VA (US)

(72) Inventors: Vikram KANMUKHLA, Glen Allen, VA (US); Rachel Sarah Salvatori, Richmond, VA (US)

(73) Assignee: Cupron, Inc., Richmond, VA (US)

(21) Appl. No.: 18/577,622

(22) PCT Filed: Jul. 7, 2022
(86) PCT No.: PCT/US2022/036379

§ 371 Date: Jan. 8, 2024

Related U.S. Application Data
(60) Provisional application No. 63/219,051, filed on Jul. 7, 2021.

(51) Int. Cl. C08J 9/00; C08G 18/76; C08K 3/22; C08K 9/04

(52) U.S. Cl. CPC C08J 9/0066; C08G 18/7621; C08G 18/7671; C08K 3/22; C08K 9/04; C08G 2110/0041; C08J 2375/04; C08K 2003/2248

(57) ABSTRACT

Antimicrobial polyurethanes and methods of producing an antimicrobial polyurethane may comprise mixing a plurality of hydrophobic antimicrobial metal compound particles to the reaction mixture. The reaction mixture may comprise a polyol and an isocyanate. The method may comprise mixing the polyol with the plurality of hydrophobic copper oxide particles to produce a polyol slurry and, subsequently, mixing the polyol slurry with an isocyanate to form a polyurethane foam. Other polyurethane articles and methods may be utilized.

### FIELD OF THE INVENTION

The present invention relates to generally to foamed plastic materials and more particularly to foamed polyurethanes having antimicrobial properties. The present invention describes a process and composition of making highly effective antimicrobial foam product with cuprous oxide that is uniformly distributed and consistent.

### BACKGROUND

Polyurethanes are ubiquitous and can be found in liquid coatings and paints, other tough elastomers such as roller blade wheels, rigid insulation, and soft flexible foams.

Flexible polyurethane foam is used as cushioning for a variety of consumer and commercial products, including bedding, furniture, automotive interiors, carpet underlay and packaging. Flexible foam can be created in almost any variety of shapes and firmness. It is light, durable, supportive and comfortable.

These flexible foam substrates, especially bedding items such as mattress, mattress toppers, pillows are excellent substrates for microorganisms to thrive and multiply. This is true in both healthcare setting and consumer setting.

Lange et al (2014) found that 38% of hospital pillows were colonized with MRSA and coliforms, and concluded that disposable pillows may provide a more sanitary option for hospital bed use. Shik et al (2014) cut open nominally fluid-proof (stitched seam) pillows in a burn unit and found that many were visibly contaminated with body fluids. Mottar et al (2006) observed a noticeable discrepancy in the weight of pillows in a burn center. Examination revealed there was body fluid leakage into the interior of the pillow through the seams and multiple pathogens were isolated from the inside of the pillow which correlated well with patient infections thus indicating a possible source of such infections. Lippmann et al (2014) sought reservoirs of infection to explain a large outbreak of Klebsiella pneumoniae carbapenemase (KPC) in Germany. They found that positioning pillows were internally contaminated and remained so for at least 6 months.

From these disclosures, it is evident that the common practice of encasing the pillow and mattress in a waterproof cover does not prevent pathogens from entering and growing within the pillow or mattress. Because a pillow necessarily compresses and expands during normal use (or other part of the anatomy), air must flow in as the pillow expands and out as the pillow compresses. It is estimated that approximately two (2) liters of air enters and/or exits the pillow in a few seconds when the pillow is compressed or expanded. In the case of a simple waterproof pillow, air may flow through an opening flap or, if the cover is stitched on, through the stitching holes of the cover seam. This latter scenario is especially troublesome. High concentrations of contaminants can be introduced to the pillow interior just inside the stitched seam (Dewhurst et al 2012). Here, they persist and incubate. Subsequently, contaminated air is expelled from the pillow through the small stitching holes as a patient lays their head on the pillow. The expelled air creates an aerosol of microbes which may persist in the ambient air for many hours, and which has the capacity to recolonize not only on the patient or the subsequent patient, but also the patient environment (Kalogerakis 2005).

The polymer materials used for the filling provide an available source of carbon and nitrogen to support growth (Jenkins et al, 2005). Woodcock et al (2006) also found that 47 species of fungus including Aspergillus fumigatus, Aureobasidium pullulans, Rhodotorula mucilaginosa were endemic in pillows.

Pulutan et al in “Antimicrobial Activity of Copper Sulfate and Copper Oxide Embedded on Polyurethane Foam”, Materials Science Forum, Vol. 917, pp. 22-26 (2018) describes CuSO₄ and CuO-deposited polyurethane foams. CuSO₄ deposited polyurethane foams were prepared by dipping the foam in CUSO₄ solution and pressing the foam. Pressing of the polyurethane foams was done to ensure the removal of air from the foam cavities and more complete contact of the solution with the foam and allow the copper ions from the solution to enter these cavities.

To deposit CuO on polyurethane foam, the CuO was added to a sodium hydroxide solution on a heat bath of 70° C. The sodium hydroxide reacts with the copper ions to form a copper hydroxide precipitate which is meta-stable and oxidizes to copper oxide. The polyurethane foam was then dipped in the solution and pressed to deposit the copper on the foam. This method of treating the polyurethane foam is cumbersome and requires special processing and handling.

In another method, Sportelli et al in “Investigation of Industrial Polyurethane Foams Modified with Antimicrobial Copper Nanoparticles”, Materials, Vol. 9, 544 (2016), described anti-microbial copper nanoparticles that were electrosynthetized and applied to the controlled impregnation of industrial polyurethane foams used as padding in textile production or as filters for air conditioning systems. This method involves the use expensive nanoparticles and the method of application may not yield in a uniform and homogenous distribution of antimicrobial activity throughout the foam substrate.

In U.S. Pat. No. 20,120,322,903, Karandikar described a method of producing the Polyurethane foam with antimicrobial properties using silver, zinc, or copper. The invention also suffers a serious drawback of lack of consistent and uniform distribution of silver saccharaniate and silver nanoparticles within the substrate resulting in considerable variability in the antimicrobial performance of the foam product. Further, the invention describes the need for complexing agents to form stable blend of antimicrobial additive.

There is a need for antimicrobial polyurethane foams. There is also a need for antimicrobial polyurethane foam fillers for pillows and mattresses, especially for pillows and mattresses used in hospitals, to prevent the growth and survival of microorganisms.

### SUMMARY

Embodiments of a method of producing a polyurethane comprise mixing a polyol, an isocyanate, and a plurality of hydrophobic antimicrobial metal compound particles to form a polyurethane foam. In such embodiments, the method may comprise mixing the polyol with the plurality of hydrophobic copper oxide particles to produce a polyol slurry and, subsequently, mixing the polyol slurry with an isocyanate to form a polyurethane foam.

The antimicrobial compound particle may include, but are not limited to, copper oxide, cuprous oxide, cupric oxide, copper iodide, zinc oxide (ZnO), silver oxide (Ag₂O). For example, the antimicrobial particles may be water-insoluble copper compound particles. The water-insoluble copper compound particles may be exposed and protruding from surfaces of the polymeric material, wherein the water-insoluble copper oxide particles release at least one of Cu+ ions and Cu++ ions upon contact with a fluid. Copper oxides may be cupric oxide or cuprous oxides.

The hydrophobic copper oxide particles do not mix well with a hydrophilic polyol. Embodiments of the hydrophobic copper oxide particles may be surface modified copper oxide particles. The surface modification may be any modification to the copper oxide particle surface that renders the hydrophobic. The surface modification may be accomplished by reacting the copper oxide surface moieties with a hydrophobic compound. For example, the copper oxide particles may be surface modified by reaction with a fatty acid such as a saturated fatty acid, for example. The fatty acid may be a stearic acid. Alternatively, a hydrophobic coating or partial coating may be applied to the copper oxide particles. The coating should be such that the copper oxide particles may release at least one of Cu+ ions and Cu++ ions upon contact with a fluid to provide antimicrobial activity.

The polyol may be any polyol capable of reacting with an isocyanate to form a polymer. As used herein, a “polyol” is a chemical compound having at least two hydroxyl groups including, but not limited to, a difunctional polyol or a diol and a compound comprising more than two hydroxyl groups, such as, but not limited to, a triol. In embodiments, exemplary polyols may possess from about 2 to about 5 hydroxyl groups. In some embodiments, the polyol may be a difunctional polyol. Additionally, the polyol may comprise amino-terminated groups.

In embodiments, a polyol may be an alkene oxide polyol, ethyene oxide polyol, propylene oxide polyol, polyether polyol, polyester polyol, polycarbonate polyol, hydrocarbon polyol, polysiloxane polyol, copolymer polyols of these polymers, combinations thereof, and the like.

In embodiments, the isocyanate may be at least one of methylene diphenyl diisocyanate, toluene diisocyanate, and a combination thereof.

Another embodiment is an antimicrobial polyurethane article. The antimicrobial polyurethane article may be a foam, fiber, coating, elastomer, or other article. An embodiment of the antimicrobial polyurethane article comprising a polyurethane and a plurality of antimicrobial particles, wherein at least a portion of the antimicrobial particles are modified to be hydrophobic.

Embodiments of the antimicrobial polyurethane article may monomers derived from the reaction of a polyol and an isocyanate. The isocyanate may be selected from a the group including, but not limited to, methylene diphenyl diisocyanate, a toluene diisocyanate, and combinations thereof.

Embodiments of polyurethane articles may include foams, mattresses, pillows, carpet padding, insulation, seat cushions, vehicle seats, wound dressings, kitchen sponges, sponges, packaging, footwear including insoles, laminates, fibers including, but not limited to, spandex fibers, and other articles. The method may be used to produce such articles. Further, the polyurethane article may be a polyurethane foam having a density greater than 3.0 lb./sq. ft.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### DESCRIPTION

Embodiments of a method of producing a polyurethane comprise mixing a polyol, an isocyanate, and a plurality of hydrophobic antimicrobial metal compound particles to form a polyurethane foam. The plurality of hydrophobic antimicrobial metal compounds may be added to the other components either separately, as part of a blend of raw materials, in a masterbatch, or a combination thereof. For example, the method may comprise mixing a masterbatch comprising a plurality of antimicrobial hydrophobic copper oxide particles with a polyol or isocyanate. Alternatively, the method may comprise mixing the polyol with the plurality of hydrophobic copper oxide particles directly to produce a polyol slurry and, subsequently, mixing the polyol slurry with an isocyanate to form a polyurethane foam.

### Antimicrobial Particles

The method and polyurethane articles may comprise any hydrophobic antimicrobial metal compound particles. The hydrophobic metal compounds include, but are not limited to, antimicrobial metal oxide particles. The metal compound should be treated to be to be hydrophobic such that they retain their antimicrobial properties in the resultant polyurethane product.

The inventors surprisingly found that hydrophobic antimicrobial particles provide improved antimicrobial efficacy and activity than other antimicrobial particles. Without limiting the invention, it is hypothesized that the hydrophobic particles are moved from the center of the foam network structure to the exterior surfaces of the network. With this structure, the polyurethane article, such as a polyurethane foam, has greater antimicrobial activity.

The hydrophobic antimicrobial compound particles that may be used in the polyurethane and the method include, but are not limited to, copper oxide, cuprous oxide, cupric oxide, copper iodide, zinc oxide (ZnO), silver oxide (Ag₂O). For example, the antimicrobial particles may be water-insoluble copper compound particles. The water-insoluble copper compound particles may be exposed and protruding from surfaces of the polymeric material, wherein the water-insoluble copper oxide particles release at least one of Cu+ ions and Cu++ ions upon contact with a fluid. Copper oxides may be cupric oxide or cuprous oxides.

The hydrophobic copper oxide particles do not mix well with a hydrophilic polyol. embodiments, the hydrophobic copper oxide particles are surface modified copper oxide particles. The surface modification may be any modification to the copper oxide particle surface that renders the hydrophobic. The surface modification may be accomplished by reacting the copper oxide surface moieties with a hydrophobic compound. For example, the copper oxide particles may be surface modified by reaction with a fatty acid such as a saturated fatty acid, for example. The fatty acid may be a stearic acid. Alternatively, a hydrophobic coating or partial coating may be applied to the copper oxide particles. The coating should be such that the copper oxide particles may release at least one of Cu+ ions and Cu++ ions upon contact with a fluid to provide antimicrobial activity.

As used herein, “hydrophobic” means that the coating or other hydrophobic modification results in a contact angle between the particles and water to be greater than 90 degrees. To improve the segregation of the particles to an exterior region of the polyurethane article, the contact angle may be greater than 120 degrees. The stearic acid modified hydrophobic copper oxide particles, used herein, have a contact angle with water of greater than 120 degrees.

The antimicrobial metal compound particles may have an average particle size in the range of 0.5 to 10 microns. In other embodiments, the copper oxide particles may have a particle having a an average particles size in 1.0 to 2.0 microns.

### Polyols

The polyol may be any polyol capable of reacting with an isocyanate to form a polymer. As used herein, a “polyol” is a chemical compound having at least two hydroxyl groups including, but not limited to, a difunctional polyol or a diol and a compound comprising more than two hydroxyl groups, such as, but not limited to, a triol. In embodiments, exemplary polyols may possess from about 2 to about 5 hydroxyl groups. In some embodiments, the polyol may be a difunctional polyol. Additionally, the polyol may comprise amino-terminated groups.

In embodiments, a polyol may be an alkene oxide polyol, ethyene oxide polyol, propylene oxide polyol, polyether polyols such as, but not limited to, polyethylene glycol, polypropylene glycol, and polytetramethylene glycol, polyester polyol such as, but not limited to, branched polyester polyols, polycarbonate polyol, hydrocarbon polyol, polysiloxane polyol, copolymer polyols of these polymers, polyols formed from cyclic ethers, combinations thereof, and the like.

### Isocyanates

In embodiments, the isocyanate may be at least one of methylene diphenyl diisocyanate, toluene diisocyanate, and a combination thereof.

Another embodiment is an antimicrobial polyurethane article. The antimicrobial polyurethane article may be a foam, fiber, coating, elastomer, or other article. An embodiment of the antimicrobial polyurethane article comprising a polyurethane and a plurality of antimicrobial particles, wherein at least a portion of the antimicrobial particles are modified to be hydrophobic.

Embodiments of the antimicrobial polyurethane article may monomers derived from the reaction of a polyol and an isocyanate. The isocyanate may be selected from a the group including, but not limited to, methylene diphenyl diisocyanate, a toluene diisocyanate, and combinations thereof.

The polyurethane article may be a polyurethane foam having a density greater than 3.0 lb./sq. ft.

### Antimicrobial Efficacy of Foam Samples

The term “antimicrobial” will be understood to encompass antibacterial, antifungal, antiviral, and/or antiparasitic activity, activity against protozoa, yeasts, and/or molds. The antimicrobial may be microbicidal or microbistatic, for example.

In examples, the hydrophobic antimicrobial particles may be water-insoluble copper compound particles. The water-insoluble copper oxide particles release at least one of Cu+ ions and Cu++ ions upon contact with a fluid. The water-insoluble copper compound particles may be exposed and protruding from surfaces of the polyurethane, wherein the water-insoluble copper oxide particles release at least one of Cu+ ions and Cu++ ions upon contact with a fluid.

### Preparation of Hydrophobic Copper Oxide

Copper oxide particles were prepare by a surface treatment with stearic acid. To prepare the stearic acid coated copper particles, 17 g of stearic acid was added to a 1-L beaker, and then 400 ml of ethanol and 200 ml of distilled water were added. The mixture was heated to 70° C. and stirred constantly until the stearic acid was completely dissolved. Next, 100 g of copper oxide particles were added to stearic acid solution, stirred constantly at 70° C. for 5 hours. The mixture was left to settle, and finally be filtered to get the product. Copper oxides coated with stearic acid were dried in a vacuum oven for 6 h at 60° C., then ground to form powder.

### Process of Polyurethane Foam Production

To make the foam slab, a plurality of hydrophobic cuprous oxide particles (as prepared above) was added to a polyol (Voranol 1447™ available from Dow Chemical) and blended to substantial uniformity using a high-speed mixer. A compatible surfactant and a compatible polymeric thickener (each at a value less than 5% w/w) along with the hydrophobic antimicrobial agent were be added to the polyol. Tin octoate was add as a catalyst at 0.1 wt. % to control initiation of the reaction.

This polyol slurry was then added to either toluene diisocyanate (TDI) or methylene diphenyl diisocyanate (MDI) and were mixed in a disposable wax paper cup. The reactants were then poured into a square shaped wax paper mold. Within minutes, the reactants poured into the mold expanded as the mixture began to foam and cure. The mold and its contents were left undisturbed under very low light inside a ventilated hood for about 30 minutes. At this time, the cured foam mass was non-tacky to touch. The foam was removed from the mold and placed on a stack of disposable paper towels and heated in microwave oven for 5-10 minutes. The sample foam was then transferred to a conventional oven at 55° C. and thoroughly dried overnight. A control foam sample was made the with the same process except the plurality of hydrophobic cuprous oxide particles were not added.

All foam samples were evaluated using AATCC-100 test method for antimicrobial efficacy. 1-inch x 1-inch samples with a 0.5-inch thickness were cut from the foam substrates for testing. The foam samples were inoculated with bacteria and were incubated for a period of time (typically 24 hour or 2 hour) referred to as contact time. After the said contact time, the bacteria were recovered from the samples by stomaching. The recovered bacteria were counted via colony forming units using serial dilution method.

TABLE 1
Antimicrobial efficacy in 24 hours

| | | | | Bacteria | |
|---|---|---|---|---|---|
| | Cuprous | | | Staphylococcus | Klebsiella |
| | Oxide | | Contact | aureus | pneumoniae |
| Sample | Content | | time | (ATTC | (ATCC |
| # | (wt %) | Diiscocyanate | (hours) | 6538) | 4352) |
| Control | 0.00% | MDI | 24 | −1.10 | −1.93 |
| 1 | | | | | |
| Test 1.1 | 0.35% | MDI | 24 | >4.81 | >5.34 |
| Test 1.2 | 1.40% | TDI | 24 | >4.81 | >5.34 |

TABLE 2
Antimicrobial efficacy in 2 hours

| | | | | Bacteria | |
|---|---|---|---|---|---|
| | Cuprous | | Contact | Staphylococcus | Pseudomonas |
| | Oxide | | time | aureus | aeruginosa |
| Sample # | Content | Diiscocyanate | (hours) | (ATTC 6538) | (ATCC 15442) |
| Control | 0.00% | MDI | 2 | −0.11 | −0.18 |
| Test 2.1 | 0.35% | MDI | 2 | >4.96 | >5.30 |
| Test 2.2 | 1.40% | TDI | 2 | 0.08 | 0.37 |

In 24-hour contact time, both samples (Test 2.1 and Test 2.2) above exhibited same efficacy and were undistinguishable from each other from antimicrobial performance perspective although sample made with MDI had lower Cuprous Oxide content. Surprisingly, in 2-hour contact time, it was discovered that the samples made with Methylene diphenyl diisocyanate (MDI) significantly performed better than the foam samples made with Toluene diisocyanate (TDI), although the MDI sample has lower Cuprous oxide content.

### Active Copper

Active Copper is determined by the measuring the amount Copper that is readily available within the foam that can be extracted without destroying the foam. A solution consisting of Bicinchoninic acid (BCA), a known copper complexing agent, is prepared in phosphate buffered solution (PBS). A known amount of foam sample is immersed in the BCA solution for 2 hours. During this period, the BCA reacts with copper to form a purple-colored BCA-Copper complex. At the end of 2 hours, a small amount of solution is obtained and the copper in the solution is estimated by colorimetric assay.

TABLE 3
Percentage of Active Copper - MDI/TDI

| | Cuprous | | | % Active Copper |
|---|---|---|---|---|
| | Oxide | | Copper | (Copper extracted |
| Sample | Content | | extracted | as a % of Cuprous |
| # | (wt %) | Diiscocyanate | by BCA | oxide in the foam) |
| Test 3.1 | 0.50% | MDI | 0.28% | 55% |
| Test 3.2 | 1.00% | | 0.56% | 56% |
| Test 3.3 | 2.00% | | 0.92% | 46% |
| Test 3.4 | 0.50% | TDI | 0.06% | 12% |
| Test 3.5 | 1.00% | | 0.12% | 12% |
| Test 3.6 | 2.00% | | 0.47% | 23% |

The % Active copper extracted from the foam samples made with TDI was in the 12% to 23% range while surprisingly, foam samples made with MDI had much higher extractable copper and was in the range of 46%-56%.

In another example, polyurethane foams were made with two different densities (2.2 lb/cubic feet and 3.5 lb/cubic feet) and compared for active copper.

TABLE 4
Percentage of Active Copper - Foam Density

| | Cuprous | | | % Active Copper |
|---|---|---|---|---|
| | Oxide | Foam | Copper | (Copper extracted |
| Sample | Content | Density | extracted | as a % of Cuprous |
| # | (wt %) | (lb/ft3) | by BCA | oxide in the foam) |
| Test 4.1 | 0.50% | 2.2 | 0.28% | 55% |
| Test 4.2 | 1.00% | | 0.56% | 56% |
| Test 4.3 | 2.00% | | 0.92% | 46% |
| Test 4.4 | 0.50% | 3.5 | 0.38% | 75% |
| Test 4.5 | 1.00% | | 0.70% | 70% |
| Test 4.6 | 2.00% | | 1.46% | 73% |

Surprisingly, Polyurethane foam samples with higher density exhibited much higher % of extractable or Active Copper.

In another example, Cuprous oxide is made hydrophobic by treating with sodium stearate. Polyurethane foams were made with regular Cuprous oxide and hydrophobic Cuprous Oxide treated with sodium stearate. These samples were compared for active copper.

TABLE 5
Active Copper - Hydrophobic/untreated cuprous oxide

| | | Cuprous | | % Active Copper |
|---|---|---|---|---|
| | | Oxide | Copper | (Copper extracted |
| Sample | | Content | extracted | as a % of Cuprous |
| # | Treatment | (wt. %) | by BCA | oxide in the foam) |
| Test 5.1 | None | 1.00% | 0.24% | 24% |
| Test 5.2 | None | 1.50% | 0.40% | 27% |
| Test 5.3 | Hydrophobic | 1.00% | 0.52% | 52% |
| Test 5.4 | Hydrophobic | 1.50% | 0.75% | 50% |

Surprisingly, Polyurethane foam samples containing Cuprous oxide with hydrophobic treatment exhibited much higher % of extractable or Active Copper than the regular Cuprous oxide.

The embodiments of the described polyurethane products and methods of producing polyurethane products are not limited to the particular embodiments, components, method steps, and materials disclosed herein as such components, process steps, and materials may vary. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A method of producing a polyurethane, comprising:
mixing a polyol and a plurality of hydrophobic copper oxide particles to form a polyol slurry; and
mixing the polyol slurry with as methylene diphenyl diisocyanate to form a polyurethane foam.

2. The method of claim 1, wherein the hydrophobic copper oxide particles are surface modified copper oxide particles.

3. The method of claim 2, wherein the copper oxide particles are surface modified by reaction with a fatty acid.

4. The method of claim 3, wherein the fatty acid is stearic acid.

5. The method of claim 4, wherein the fatty acid comprises a hydrophobic tail.

6. The method of claim 2, wherein the copper oxide particles are surface modified by a reaction oleic acid or palm oil.

7. The method of claim 2, wherein the copper oxide particles are surface modified by reaction with a saturated fatty acid.

8. The method of claim 1, wherein the polyurethane foam has a density greater than 3.0 g/cc.

9. (canceled)

10. The method of claim 1, comprising mixing at least one of a polymeric thickener and a surfactant with the polyol and copper oxide.

11. The method of claim 1, comprising reacting the copper oxide surface moieties with a hydrophobic compound.

12. The method of claim 1, wherein the hydrophobic compound is a fatty acid.

13. An antimicrobial polyurethane article, comprising:
a polyurethane; and
a plurality of copper oxide particle, wherein at least a portion of the copper oxide particles have a hydrophobic coating on their surface.

14. The antimicrobial polyurethane article of claim 11, wherein the polyurethane comprises monomers derived from at least one of methylene diphenyl diisocyanate.

15. The antimicrobial polyurethane article of claim 11, wherein the polyurethane article is a polyurethane foam and has a density greater than 2.0 g/cc.

16. The antimicrobial polyurethane article of claim 11, wherein the polyurethane article is a polyurethane foam and has a density greater than 3.0 g/cc.

17. The antimicrobial polyurethane article of claim 11, wherein the polyurethane article is at least one of a mattress, a pillow, carpet padding, insulation, a seat cushion, a vehicle seat, a wound dressing, a kitchen sponge, a sponge, packaging, footwear including insoles, a laminate, fibers, and, spandex fiber.
